(19) United States
(12) Patent Application Publication
(10) Pub. No.: US 2003/0030755 A1
(43) Pub. Date: Feb. 13, 2003

(54) System and method of displaying searched channel during automatic search

(75) Inventor: Jin-woo Ahn, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD

(21) Appl. No.: 10/191,080

(22) Filed: Jul. 10, 2002

(30) Foreign Application Priority Data
Aug. 11, 2001 (KR) 2001-48537

(51) Int. Cl. G06F 3/00; H04N 5/445; G06F 13/00; H04N 5/50

(52) U.S. Cl. 348/732; 725/37; 348/564; 348/731

(57) ABSTRACT

A television set has a first and second tuner for detecting a broadcasting signal of searched channel, and a controller for controlling the first and second tuners. An output of the first tuner is displayed on a main screen, and the output of the second tuner is displayed on a PIP screen. The controller controls the second tuner to perform an automatic search for a plurality of channels, and the channel searched by the second tuner is stored in a storage unit. The controller controls the first tuner to output the broadcasting signal of a certain channel among the channels searched by the second tuner during the automatic search. The certain channel can be a first channel searched among the channels searched by the second tuner, or a channel having a level of the broadcasting signal higher than a predetermined level among the channels searched by the second tuner.

### BACKGROUND OF THE INVENTION

1. Field of the Invention

The present invention relates to a system and method of displaying an automatic channel search for a television set, and more particularly, to a television set and method of displaying one of a plurality of searched channels on a main screen during the automatic search by a picture-in picture (PIP) tuner.

The present application is based on Korean Patent Application No. 2001-48537, filed Aug. 11, 2001, which is incorporated herein by reference.

2. Description of the Related Art

Generally, a related art television set is an apparatus that receives a wireless signal transmitted from a broadcasting station or an input signal from an outside source such as a CATV (Cable Television), and displays an image from the received signal. If a user selects a broadcasting channel by manipulating a remote controller or a key panel, the related art television set tunes a broadcasting signal corresponding to the selected broadcasting channel, and outputs the tuned broadcasting signal.

The related art television set has various functions for user convenience, including an automatic search function that automatically selects the broadcasting channel. A related art system for offering various broadcasting through dozens of channels such as CATV has become generally available, and most television sets have the related art automatic search function. Thus, so that the user need not manually input all the channels that he or she wants to watch.

FIG. 1 is a flow chart showing a related art automatic search method performed in a general television set. At step S11, if the user inputs a command for automatic channel search into the related art television set by manipulating the remote controller. Then, at step S12, a microprocessor in the related art television set stores a start channel (e.g., channel 2) in a range of channels to be selected (e.g., channel 2 to channel 125). Next, at step S13, the microprocessor detects whether the broadcasting signal exists in the channel by using a tuner.

If the broadcasting signal is detected at step S13, the microprocessor stores a number of the channel at step S16, and at step S17, the channel number is incremented by one. However, if no broadcasting signal is detected at step S13, then step S16 is skipped, as the channel number is not stored.

Then, the microprocessor checks if the increased channel number is the number of the last channel in the range of channels at step S18. The last channel is the channel of the same number as the start channel. If the searched channel is the last channel, then the automatic search for the channels that have the broadcasting signal is finished. Otherwise, steps S13-S18 are repeated until the automatic search has been completed.

However, the related art television set and automatic search method have various problems and disadvantages. For example, but not by way of limitation, during the related art automatic search, the user cannot watch any of the channels until the automatic search is finished. In other words, during the automatic search, the channel being searched is consecutively displayed on the screen, and no image can be displayed on a CRT screen. Also, undesired noise is heard from an output of a speaker.

Particularly, for the related art television set that provides a PIP (Picture-in-Picture) function with a plurality of tuners, the PIP screen cannot be provided in a stable manner, since a synchronizing signal of the PIP screen does not exist during the related art automatic search performed on a main screen. Thus, the synchronizing signal of the PIP screen must be generated by mixing the synchronizing signal of a PIP broadcasting signal based on a synchronizing signal of the main screen, and because a stable image cannot be provided on the main screen for at least the reasons noted above, a stable image also cannot be provided on the PIP screen.

### SUMMARY OF THE INVENTION

It is an object of the present invention to overcome the above-mentioned problems of the related art.

Accordingly, it is an object of the present invention to provide a television set capable of outputting a broadcasting signal of a certain channel during an automatic search so that a user can watch a program during the automatic search, and a method for the automatic search of the same.

To accomplish the foregoing objects, an apparatus for receiving a television signal is provided, comprising a first tuner configured to tune to one of a plurality of available channels, and a second tuner configured to tune to one of the plurality of available channels. Additionally, the apparatus comprises a controller configured to (a) cause the second tuner to scan the plurality of available channels to automatically detect at least one signal present channel and (b) during the scan, cause the first tuner to tune to a prescribed channel of the at least one signal present channel, the controller being configured to display the prescribed channel tuned on an interface.

Additionally, a method for automatically scanning a television signal, comprising the steps of (a) causing a second tuner to scan a plurality of available channels to automatically detect signal present channels, (b) during the (a), causing a first tuner to tune to a prescribed channel of the automatically detected signal present channels, and (c) displaying the particular one of the automatically detected signal present channels, tuned by the first tuner, on an interface.

The above object is accomplished by a television set according to the present invention comprising: a first and a second tuner for respectively detecting broadcasting signals and outputting the broadcasting signals for use of a main screen and a PIP screen respectively; a controller for controlling (a) the second tuner in order to perform an automatic search consecutively for a plurality of channels, and (b) the first tuner in order to tune the broadcasting signal of a certain channel among the channels searched by the second tuner during the automatic search of the second tuner; and a storage unit for storing data of the channels searched by the second tuner.

Here, the certain channel can be a channel that has been firstly searched among the channels searched by the second tuner, or a channel having a level of the broadcasting signal higher than a predetermined level among the channels searched by the second tuner. At this time, the level of the broadcasting signal is judged based on a voltage used for automatic gain control for the searched channels.

Additionally, a method for displaying a searched channel of the television set according to the present invention comprises the steps of: consecutively searching a plurality of channels by using a tuner for a PIP screen; and outputting the broadcasting signal of the certain channel among the channels searched by the tuner on the main screen during the searching step.

According to the present invention, a channel having the broadcasting signal is displayed on the main screen during the automatic search through the PIP screen. Moreover, an output status of the PIP screen that performs the automatic search has improved quality.

### BRIEF DESCRIPTION OF THE DRAWINGS

The above-mentioned objects and the features of the present invention will be more apparent by describing the preferred embodiment of the present invention by referring to the appended drawings, in which:

FIG. 1 is a flow chart showing related art steps of an automatic search;

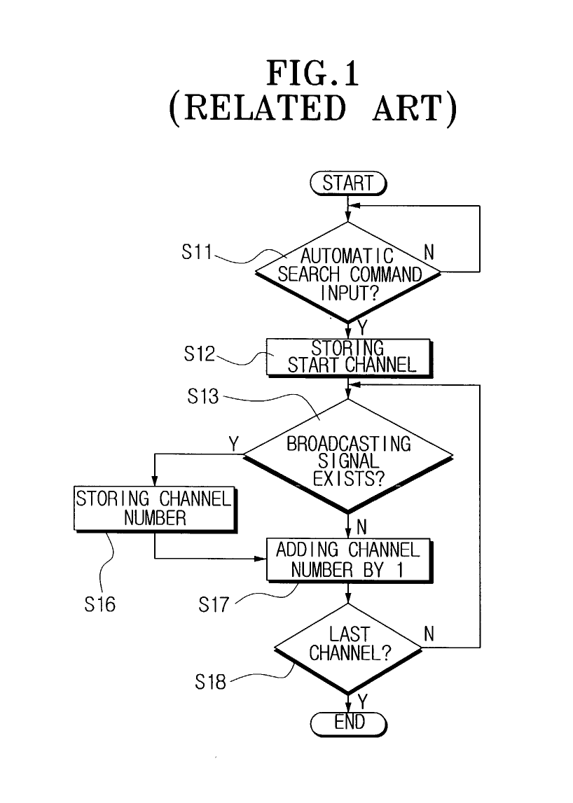

FIG. 2 is a block diagram showing a television set capable of performing an automatic search according to the present invention;

FIG. 3 is a flow chart showing steps of the automatic search according to a first preferred method of the present invention performed by the television set shown in FIG. 2; and

FIG. 4 is a flow chart showing steps of the automatic search according to a second preferred method of the present invention performed by the television set shown in FIG. 2.

### DESCRIPTION OF THE PREFERRED EMBODIMENTS

Reference will now be made in detail to the preferred embodiment of the present invention, examples of which are illustrated in the accompanying drawings. In the present invention, the terms are meant to have the definition provided in the specification, and are not otherwise limited by the specification.

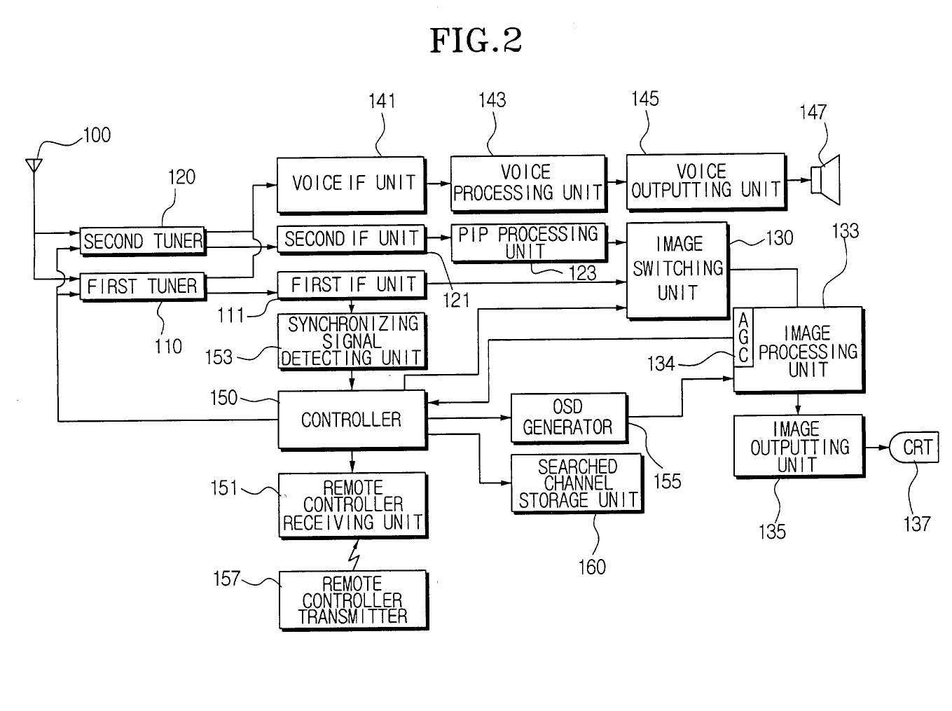

FIG. 2 is a block diagram of a television set having a picture-in-picture (PIP) function according to the present invention. A first and second tuners 110, 120 tune a channel searched by a predetermined searched channel controlling signal, which is input from a controller 150 by a RF (Radio Frequency) signal received through an antenna 100. At this time, the first tuner 110 tunes a channel that is output on a main screen of a CRT 137, and the second tuner 120 tunes a channel that is output on a PIP screen of the CRT 137.

A first intermediate frequency (IF) unit 111 and a second IF unit 121 produce a composite video signal for the main screen and the PIP screen by receiving respective video intermediate frequencies (usually about 45.75 MHz) produced at the first tuner 110 and the second tuner 120, and demodulating the video IF. In addition, a voice IF unit 141 produces an audio signal by receiving and demodulating a sound intermediate frequency (usually about 41.25 MHz) produced at the first tuner 110 or the second tuner 120.

The signal tuned by the second tuner 120 is input into a PIP processing unit 123 that converts the signal input from the second tuner 120 into a signal that is output on the PIP screen of the CRT 137. The respective outputs of the PIP processing unit 123 and the first IF unit 111 are input into an image switching unit 130 that performs a switching operation in accordance with a control of a controller 150, for the output signal of the first IF unit 111 and the output signal of the PIP processing unit 123. The switched signal is then output to the CRT 137 through an image processing unit 133 and an image outputting unit 135. Therefore, the PIP screen is selectively displayed on the CRT 137 in accordance with the switching of the image switching unit 130.

The image processing unit 133 produces a luminance signal and a color difference signal by separating a horizontal synchronizing signal and a vertical synchronizing signal from a composite video signal input from the image switching unit 130, and generates a RGB signal based on the luminance signal and the color difference signal. The image processing unit 133 combines the generated RGB signal with a RGB signal input from an OSD generator 155, and outputs the combined signal to the image outputting unit 135. Furthermore, the image processing unit 133 outputs an AGC (automatic gain control) signal through an AGC terminal 134 to control amplification in accordance with the level of transmitted signals of each channel, and transmits the AGC signal to the controller 150.

An output of the voice IF unit 141 is transmitted to a speaker 147 via a voice processing unit 143 for signaling the audio signal, and a voice output unit 145 for amplifying the output of the voice processing unit 143. Accordingly, the audio signal of the channel selected by the first tuner 110 and the second tuner 120 is output via the speaker 147.

A synchronizing signal detecting unit 153 transmits the horizontal synchronizing signal and the vertical synchronizing signal to the controller 150 by receiving the output signal of the first IF unit 111 and outputting the horizontal synchronizing signal and the vertical synchronizing signal.

The controller 150 controls the aforementioned system of the present invention illustrated in FIG. 2 in accordance with the input command by receiving the signal from a remote controller transmitter 157 via a remote controller receiving unit 151, or from a key panel manipulated by the user, and stores the number of the searched channel in the searched channel storage unit 160.

If the user inputs the command for the automatic channel search by manipulating the remote controller receiving unit 151, the controller 150 selects the channel by outputting the searched channel controlling signal to the second tuner 120, and judges whether the broadcasting signal has been detected in accordance with the synchronizing signal read from the synchronizing signal detecting unit 153.

In addition, the controller 150 can recognize the level of the broadcasting signal of the searched channel, and search the channel by detecting the broadcasting signal. The broadcasting signal level is measured based on an output voltage of the AGC terminal 134. In other words, when the broadcasting signal level is low, the output voltage of the AGC terminal 134 is increased to increase a gain of the output of the broadcasting signal. When the broadcasting signal level is high, the output voltage of the AGC terminal 134 is reduced, since the gain of output of the broadcasting signal can be low. Thus, the level of the broadcasting signal is measured based on the output voltage of the AGC terminal 134.

For example, but not by way of limitation, if the output voltage of the AGC terminal 134 is higher than about 3.5V, the broadcast signal level is characterized as a weak signal. If the output voltage of the AGC terminal 134 is about 3.4V to about 2.5V, then the broadcast signal level is characterized as a normal signal. Further, if the output voltage of the AGC terminal is less than about 2.4V, then the broadcast signal level is characterized as a strong signal.

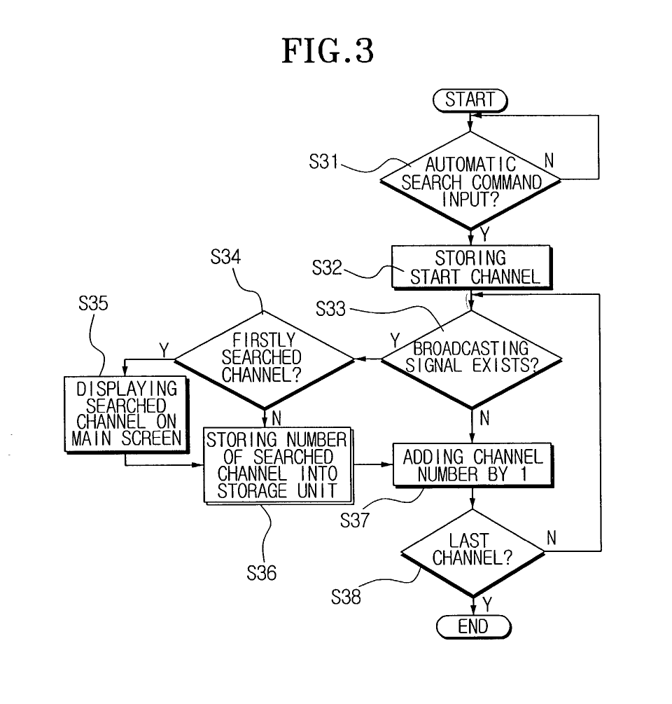

FIG. 3 illustrates a first method for displaying the searched channel according to the present invention. At step S31, if the user inputs a command for the automatic search by manipulating the remote controller transmitter 157, the command is input into the controller 150 via the remote controller receiving unit 151, and the controller 150 performs the automatic search by consecutively changing the channels by operating the second tuner 120.

At step S32, the controller 150 first stores a start channel (e.g., channel 2) among the channels that are automatically searched (e.g., from channel 2 to channel 125). Next, the controller 150 determines if the broadcasting signal exists in the current channel at step S33. The existence of the broadcasting signal can be recognized by the existence of the synchronizing signal at the synchronizing signal detecting unit 153.

If the broadcasting signal exists as determined in step S33, then at step S34, the controller 150 determines whether the current channel is the firstly searched channel. Step S34 can be performed in various ways. For example, but not by way of limitation, the controller 150 sets an initial value of a certain register in the controller 150 as a certain value (e.g., ‘00’), and when a channel determined to have the broadcasting signal is detected, the controller 150 adds a value of 1 to the register. According to the present method, because the number of the searched channel is recorded in the register, if the value of the register is ‘01’, then it can be determined that the currently searched channel is the first searched channel.

If the currently searched channel is the first searched channel as determined in step S34, the controller 150 displays the currently searched channel on the main screen at step S35 and then stores the currently searched channel in the searched channel storage unit 160 at step S36. To implement step S35, the controller 150 controls the first tuner 110 to tune the channel that is the same channel as the first channel, which was searched by the second tuner 120. Accordingly, the channel searched by the first tuner 110 is output on the main screen of the CRT 137 through the first IF unit 111, the image switching unit 130, the image processing unit 133, and the image output unit 135.

However, when the currently searched channel is not the first searched channel (i.e., the currently searched channel is at least a second searched channel), step S35 is skipped and the controller 150 stores the currently searched channel in the searched channel storage unit 160 at step S36.

When steps S33-S36 are completed, the controller 150 increments the number of the current channel by 1 at step S37, and checks if the added channel is the last channel at step S38. The last channel has the same number as the channel number recorded as the start channel in the step S32. According to the foregoing example, if the start channel is channel 2, after completing the search of the channels up to channel 125, the incremented channel in step S37 becomes channel 2 again (i.e., the start channel). Therefore, when the current channel is the same as the start channel, the current channel is the last channel, and the controller 150 stops the automatic search. If the current channel is not the last channel, steps S33 to S38 are repeated until the last channel is reached.

According to the present invention, during the automatic search by the second tuner 120, the first tuner 110 outputs the broadcasting signal of the first searched channel among the channels searched by the second tuner 120. Thus, the broadcasting signal of the first searched channel is displayed on the main screen of the CRT 137, and the channel automatically searched by the second tuner 120, in other words, a signal corresponding to each channel consecutively being added is displayed on the PIP screen of the CRT 137. Moreover, the voice IF unit 141 outputs the voice signal of the broadcasting signal output by the first tuner 110, and thus the voice corresponding to the main screen is output from the speaker 147.

Therefore, according to the present invention, the user can watch the broadcasting signal of the first searched channel on the main screen during the automatic search performed on the PIP screen. In addition, since the first tuner 110 tunes the main screen having the broadcasting signal during the automatic search, a stable synchronizing signal is output at the synchronizing signal detect unit 153. Accordingly, for the television set having the PIP function that produces the synchronizing signal of the PIP screen by using the synchronizing signal of the main screen, the output of the PIP screen can be generated in a stable manner. Moreover, when the channel having the broadcasting signal is detected by the second tuner 120 during the automatic search, the PIP screen of the searched channel has an improved quality.

While the foregoing exemplary description includes a case in which the broadcasting signal of the firstly searched channel is displayed on the main screen, the present invention is not limited thereto. For example, but not by way of limitation, the broadcasting signal of another channel that is not the firstly searched channel can be also displayed on the main screen, including, but not limited to, channels searched second or third, or a broadcasting signal of a predetermined channel (e.g., set up in advance by the user).

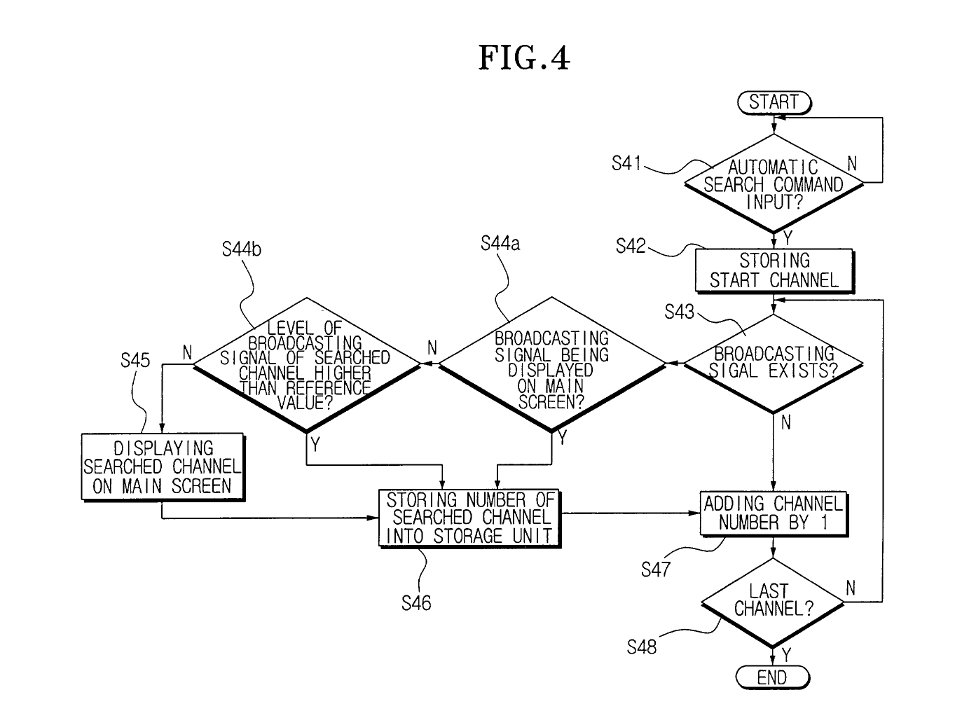

FIG. 4 shows another preferred method of the present invention, in which the channel that is displayed on the main channel is set up as another channel. In FIG. 4, all the steps of such as inputting the command for the automatic search (step S41), storing the start channel (step S42), determining the existence of the broadcasting signal (step S43), adding 1 to the number of the channel when there is no broadcasting signal in the current channel (step S47), and determining if the current channel is the last channel (step S48) are substantially the same as the preferred embodiment of the present invention shown in FIG. 3 and described above. Therefore, additional description of the aforementioned steps is omitted.

The second preferred method of the present invention shown in FIG. 4 has a different criteria for selecting the channel displayed on the main screen from the first preferred method of the present invention. In other words, when the channel displayed on the main screen does not have the broadcasting signal as shown in step S44A, the level of the broadcasting signal of the channel determined to have the broadcasting signal in step S43 is detected at step S45, as described in greater detail below.

If the level of the broadcasting signal is higher than a reference (e.g., prescribed) value, then the broadcasting signal of the channel is displayed on the main screen at step S45, and the number of the channel is stored in the searched channel storage unit 160 at step S46. However, if the broadcasting signal is the channel displayed on the main screen in step S44A, or if the broadcasting signal level of the channel searched in step S44B is lower than the reference value, step S45 is skipped and step S46 is performed as described above. The level of the broadcasting signal can be easily measured by detecting the output voltage of the AGC terminal 134 by the controller 150, as described above.

According to the aforementioned preferred embodiment of the present invention, the broadcasting signal of the searched channel is displayed on the main screen of the CRT 137, only when the level of the broadcasting signal is high enough to provide an image with acceptable quality among the searched channels. Thus, it is preferable that the reference value of the level of the broadcasting signal should be set at a sufficiently high level to display an image with acceptable quality. In an embodiment of the present invention, during the automatic search on the PIP screen, an image of the first channel detected to be enough to display a good image among the searched channels is displayed on the main screen.

The present invention has various advantages. For example, but not by way of limitation, during the automatic search performed on the PIP screen, the channel having the broadcasting signal is displayed on the main screen. Thus, the user can watch that channel during the automatic search, and the sound of the image is output to the speaker without any substantial noise interference. Moreover, the output status of the PIP screen improves during the automatic search.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited to the described range of the following claims.

What is claimed is:

1. An apparatus for receiving a television signal, comprising:
a first tuner configured to tune to one of a plurality of available channels;
a second tuner configured to tune to one of said plurality of available channels; and
a controller configured to (a) cause said second tuner to scan said plurality of available channels to automatically detect at least one signal present channel and (b) during said scan, cause said first tuner to tune to a prescribed channel of said at least one signal present channel, said controller being configured to display said prescribed channel tuned on an interface.

2. The television set of claim 1, wherein said first tuner is operable to output to a main screen, and said second tuner is operable to output to a sub screen.

3. The television set of claim 1, wherein said prescribed channel is a first scanned signal present channel.

4. The television set of claim 3, wherein said prescribed channel is automatically detected and has a broadcasting signal at a level higher than a predetermined level.

5. The television set of claim 4, wherein said level of said broadcasting signal is determined based on an auto gain control voltage with respect to said at least one signal present channel.

6. A method for automatically scanning a television signal, comprising:
(a) causing a second tuner to scan a plurality of available channels to automatically detect signal present channels;
(b) during said (a), causing a first tuner to tune to a prescribed channel of said automatically detected signal present channels; and
(c) displaying said particular one of said automatically detected signal present channels, tuned by said first tuner, on an interface.

7. The method of claim 6, further comprising:
determining whether said automatically detected signal present channels includes a first scanned channel detected during said automatic scanning, wherein
said prescribed channel is determined to be the first scanned channel.

8. The method of claim 6, further comprising:
detecting a level of a broadcasting signal of said automatically detected signal present channels, wherein
said prescribed channel is one of said channels detected by said second tuner that has said level of said broadcasting signal higher than a predetermined level.

9. The method of claim 8, wherein said level of said broadcasting signal is determined based on an auto gain control voltage with respect to said detected channels.
